(19) United States
(12) Patent Application Publication
(10) Pub. No.: US 2019/0297955 A1
(43) Pub. Date: Oct. 3, 2019

(54) My Dry Bib

(71) Applicants: Teresa Tara Gladney, Virginia Beach, VA (US); Tamara Malika Dunston, Kennesaw, GA (US)

(72) Inventors: Teresa Tara Gladney, Virginia Beach, VA (US); Tamara Malika Dunston, Kennesaw, GA (US)

(21) Appl. No.: 15/943,580

(22) Filed: Apr. 2, 2018

(51) Int. Cl. A41B 13/10; B32B 5/26

(52) U.S. Cl. CPC A41B 13/10; B32B 5/26; A41B 2400/62; B32B 2437/00; A41B 2400/20; B32B 2262/062; A41B 2300/32

(57) ABSTRACT

A moisture protective bib comprised of dry fit technological textile. The moisture block composition decreases the likelihood of moisture moving from the wearer to wearer's clothing and skin beneath clothing. The garment keeps the front of the wearer's clothes dry. Neck section covers the upper torso; two collar fasteners extend bilateral. Each fastener has one of a complementary set of fastener at the end to secure collar around the neck of the wearer.

### BACKGROUND TO THE INVENTION

Garment comprised of a body to include an exterior layer consisting of cotton material which is formed to open to receive the baby's neck rear surface of the body portion from engagement with the baby's skin. The garment blocks baby drool moving moisture away from fabric beneath the bib and baby's skin beneath the fabric. Drool is absorbed and contained on bib's surface. Fabric features ventilations zone allowing air flow where its need. It keeps clothing, beneath the bib, dry and comfortable. Outer back exterior layer and front exterior layer are composed of cotton material to make its soft touch composition. Interior layer is composed of dry fit technological material.

### SUMMARY OF THE INVENTION

The garment keeps drool from moving to wearer's skin and clothing. Drool on clothing is problematic because it produces undesirable baby saliva that moves to clothing. Garment blocks moisture inhibiting transfer of baby drool to clothing. The bib has a flexible body with three layers of material. The garment keeps baby's chest area dry and comfortable. Front and back exterior layers are composed of cotton fabric. Interior layer contains durable dry fit technological material featuring ventilation zone to allow air where it is most needed. Velcro is used for fastening straps. Body portion defines an opening to receive the baby's neck, co-operating fastening provided at adjacent ends of the straps to enable adjustable fastening of the bib around the baby's neck. Velcro fastening straps cooperate with the body portion to retain the bib's upright utility functionality.

### BRIEF DESCRIPTION OF THE DRAWINGS

Method of making the protective bib's interior is comprised of dry fit technology fabric composition. The front and back exterior are comprised of cotton material. The inner body interior of the garment contains durable dry fit fabric featuring ventilation zone to allow air where it is most needed. Velcro is used as opening and closing fastening straps.

FIG. 1 is front perspective view of the bib as worn

FIG. 2 is back interior perspective view of the bib; the black broken line showing moisture resistance fabric in accordance with the design

FIG. 3 is back exterior perspective view of the bib with opening and closing strap.

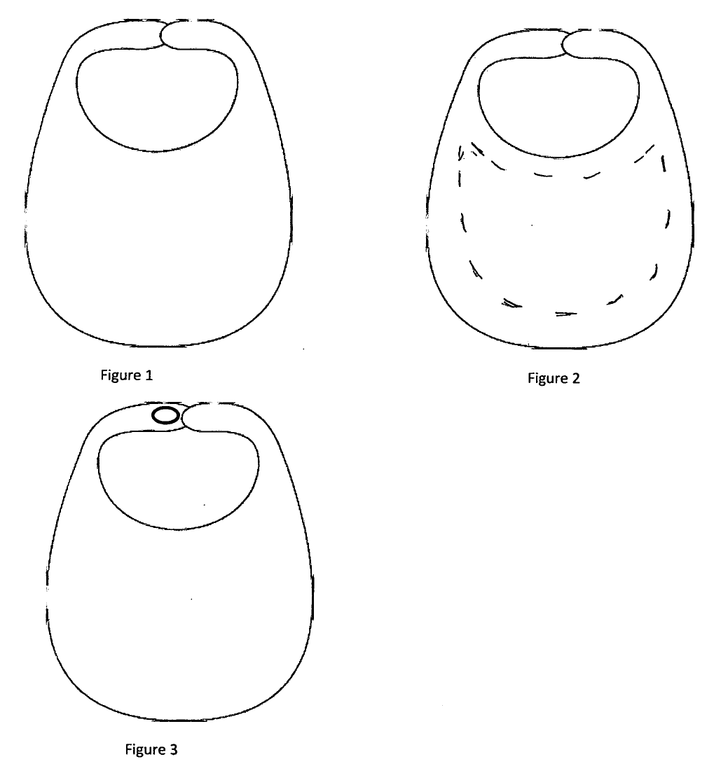

1. Moisture control bib; dry fit microfiber moisture wicking textile composition.
